(19) United States
(12) Patent Application Publication
(10) Pub. No.: US 2007/0277045 A1
(43) Pub. Date: Nov. 29, 2007

(54) DATA PROCESSING APPARATUS AND A METHOD FOR PROCESSING DATA

(75) Inventors: Shinichi MATSUKAWA, Tokyo (JP); Norikazu Hosaka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Kabushiki Kaisha Toshiba, Tokyo (JP); TOSHIBA SOLUTIONS CORPORATION, Tokyo (JP)

(21) Appl. No.: 11/753,144

(22) Filed: May 24, 2007

(30) Foreign Application Priority Data
May 25, 2006 (JP) 2006-145807

(51) Int. Cl. H04L 9/00; G06F 12/14; H04L 9/32; G06F 11/30

(52) U.S. Cl. 713/189; 713/181; 713/187; 713/176

(57) ABSTRACT

A data processing apparatus for managing an information file to be utilized when contents are used is provided. The data processing system includes an update information file creator for creating an update information file on the basis of an information file including multiple kinds of data stored in a predetermined file storage area to be stored in the predetermined file storage area, a first digest calculator for calculating a digest value from the update information file created by the update information file creator, a digest updater for updating a digest value stored in a predetermined digest value storage area to the digest value calculated by the first digest calculator, a file eraser for erasing the information file used to create the update information file, and a first file setter for setting the update information file as an information file.

### CROSS-REFERENCE TO RELATED APPLICATION

The present disclosure relates to subject matter contained in Japanese Patent Application No. 2006-145807, filed on May 25, 2006, the disclosure of which is expressly incorporated herein by reference in its entirety.

### BACKGROUND OF THE INVENTION

1. Field of the Invention

The present invention relates to a data processing apparatus and a data processing method for utilizing contents by using a bundle of decrypt keys. In particular, the present invention relates to a data processing apparatus and a data processing method in which a recovery function when an update process for a file including a bundle of decrypt keys is interrupted is provided.

2. Description of the Related Art

Heretofore, it is widely used to deliver contents, such as music data and image data, via a communication network such as the Internet. In recent years, in a field of delivery of contents, it has been proposed a content reproducing system for delivering a bundle of decrypt keys including a plurality of decrypt keys when a plurality of encoded contents are to be delivered (for example, see Japanese Patent Application Publications No. 2002-74832, No. 2001-75868 and No. 2001-51906). In the content reproducing system, the respective encoded contents can be decoded using the plurality of decrypt keys.

Information relating to corresponding contents may be added to a decrypt key. As the added information, for example, information that may be changed every moment, such as a reproduction number counter and a permitted reproduction period of time, may be mentioned. The added information is information for preventing falsification and the like by a malicious user. The added information is treated as information to be protected. As a system of the protection, for example, as shown in FIG. 13, in a client machine, a digest value is created from information, which is a target of the protection stored in a user data area section, using a transformation function such as a Hush function (digest calculator). In the client machine, it is conceivable that the created digest value is encoded using a medium ID (IDm) of a system area section as an encryption key, and that the created digest value is stored in a protected area provided for the purposes of preventing falsification and the like by a malicious user. In this case, as shown in FIG. 14, a digest value calculated from an information file stored in the user data area section within a data storage section may be checked against a digest value obtained by decoding encoded data that is likewise stored in the protected area of the data storage section using the medium ID (IDm) of the system area section as an encryption key. Further, in the case where a check result is concordance, it may be determined that the information file in the user area section is constituted from regular data, which have not suffered falsification or the like by a malicious user yet.

However, such a protection system as described above requires two steps when a digest value of an information file is to be updated in which one step is to update an information file itself and another step is to update a digest value thereof. For this reason, there has been a problem that the information file cannot be restored to an original state thereof in the case where an update process for an information file is interrupted before the update process for the digest value is completed.

### SUMMARY OF THE INVENTION

The present invention is made in view of the problem mentioned above. It is one object of the present invention to provide a data processing apparatus and a data processing method which can restore an information file even in the case where an update process for the information file is interrupted before the update process is completed.

In order to achieve the above object, an aspect of the present invention is directed to a data processing apparatus for managing an information file to be utilized when contents are used. The data processing apparatus of the present invention includes a first update information file creator for creating an update information file on the basis of an information file stored in a predetermined file storage area, and for storing the created update information file in the predetermined file storage area.

The data processing apparatus also includes a first digest calculator for calculating a digest value from the update information file created by the first update information file creator.

The data processing apparatus also includes a digest updater for updating a digest value stored in a predetermined digest value storage area to the digest value calculated by the first digest calculator.

The data processing apparatus also includes a file eraser for erasing the information file used to create the update information file.

The data processing apparatus also includes a first file setter for setting the update information file as an information file.

According to the data processing apparatus of the present invention, it is possible to execute an update process for a protected information file so as to be recoverable even in the case where the update process is interrupted without completing the update process.

Further, it is preferable that the data processing apparatus of the present invention further includes: a second digest calculator for reading out the information file stored in the predetermined file storage area, the second digest calculator calculating a digest value from the read out information file; a first digest checker for checking the digest value calculated by the second digest calculator against the digest value stored in the predetermined digest value storage area; a second update information file creator for creating an update information file on the basis of the information file stored in the predetermined file storage area in the case where a check result of the first digest checker is not concordance; a third digest calculator for calculating a digest value from the update information file created by the second update information file creator; a second digest checker for checking the digest value calculated by the third digest calculator against the digest value stored in the predetermined digest value storage area; and a second file setter for setting the update information file as an information file in the case where a check result of the second digest checker is concordance.

According to the data processing apparatus of the present invention, it is possible to recover a protected information file in the case where an update process for the protected information file is interrupted without completing the update process.

Moreover, in one embodiment of the present invention, it is preferable that the method further includes creating an update information file on the basis of an information file stored in a predetermined file storage area, and storing the created update information file in the predetermined file storage area.

The method also includes calculating a digest value from the update information file created in the creating an update information file step.

The method also includes updating a digest value stored in a predetermined digest value storage area to the digest value calculated in the calculating a digest value step.

The method also includes erasing the information file used to create the update information file.

The method also includes setting the update information file as an information file.

According to the data processing method of the present invention, it is possible to execute an update process for a protected information file so as to be recoverable even in the case where the update process is interrupted without completing the update process.

Further, it is preferable that the method of the present invention includes: reading out an information file stored in the predetermined file storage area, and calculating a digest value from the read out information file; checking the digest value calculated from the read out information file against the digest value stored in the predetermined digest value storage area; creating an update information file on the basis of the information file stored in the predetermined file storage area in the case where a check result in the checking the digest value calculated from the read out information file step is not concordance; calculating a digest value from the created update information file; checking the digest value calculated from the update information file against the digest value stored in the predetermined digest value storage area; and setting the update information file as an information file in the case where a check result in the checking the digest value calculated from the update information file step is concordance.

According to the data processing method of the present invention, it is possible to recover a protected information file in the case where an update process for the protected information file is interrupted without completing the update process.

Therefore, according to the present invention, it is possible to execute an update process for a protected information file so as to be recoverable even in the case where the update process is interrupted without completing the update process.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings.

FIG. 1 is a block diagram that illustrates a constructive example of a part according to a data updating process in a data processing system to which the present invention is applied.

FIG. 2 is a flowchart that illustrates an example of the data updating process that the data processing system executes.

FIG. 3 is an explanatory drawing that shows an outline of the data updating process that the data processing system executes.

FIG. 4 is an explanatory drawing that shows an outline of the data updating process that the data processing system executes.

FIG. 5 is an explanatory drawing that shows an outline of the data updating process that the data processing system executes.

FIG. 6 is an explanatory drawing that shows an outline of the data updating process that the data processing system executes.

FIG. 7 is a block diagram that illustrates a constructive example of a part according to a data restoring process in the data processing system to which the present invention is applied.

FIG. 8 is a flowchart that illustrates an example of the data restoring process that the data processing system executes.

FIG. 9 is an explanatory drawing that shows an outline of the data restoring process that the data processing system executes.

FIG. 10 is an explanatory drawing that shows an outline of the data restoring process that the data processing system executes.

FIG. 11 is an explanatory drawing that shows an outline of the data restoring process that the data processing system executes.

FIG. 12 is an explanatory drawing that shows an outline of the data restoring process that the data processing system executes.

FIG. 13 is an explanatory drawing that shows an outline of a conventional process for writing an information file.

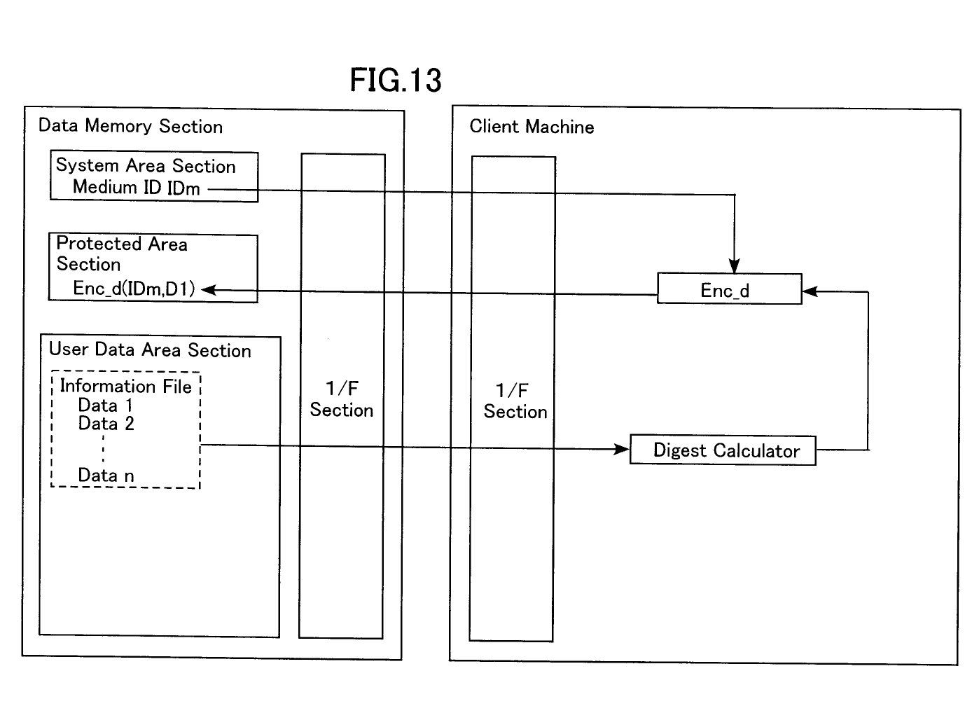

FIG. 14 is an explanatory drawing that shows an outline of a conventional process for verifying an information file.

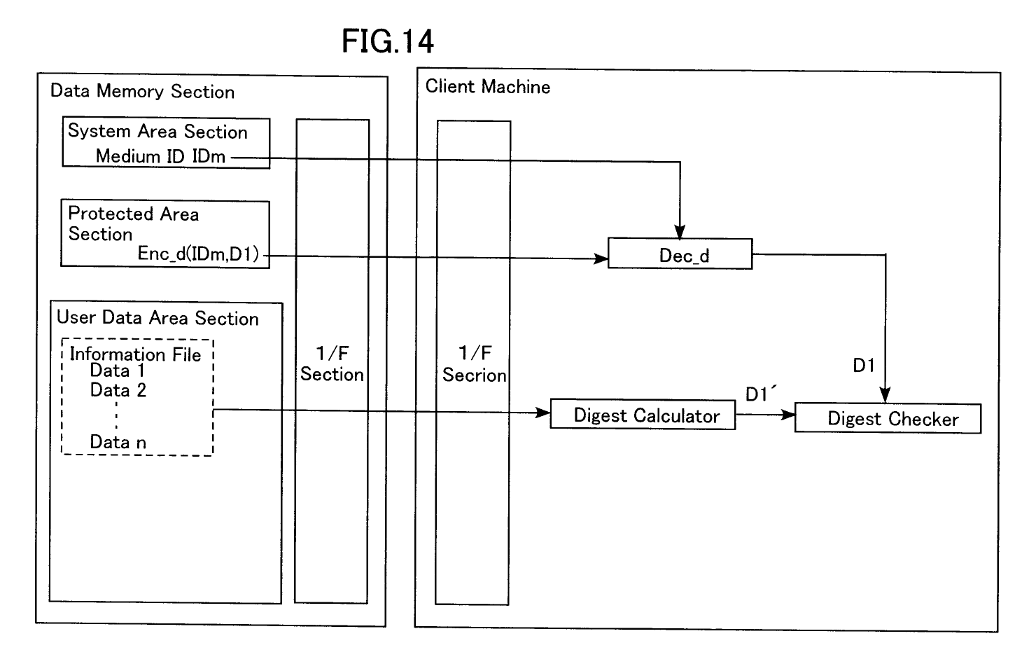

### DETAILED DESCRIPTION OF THE INVENTION

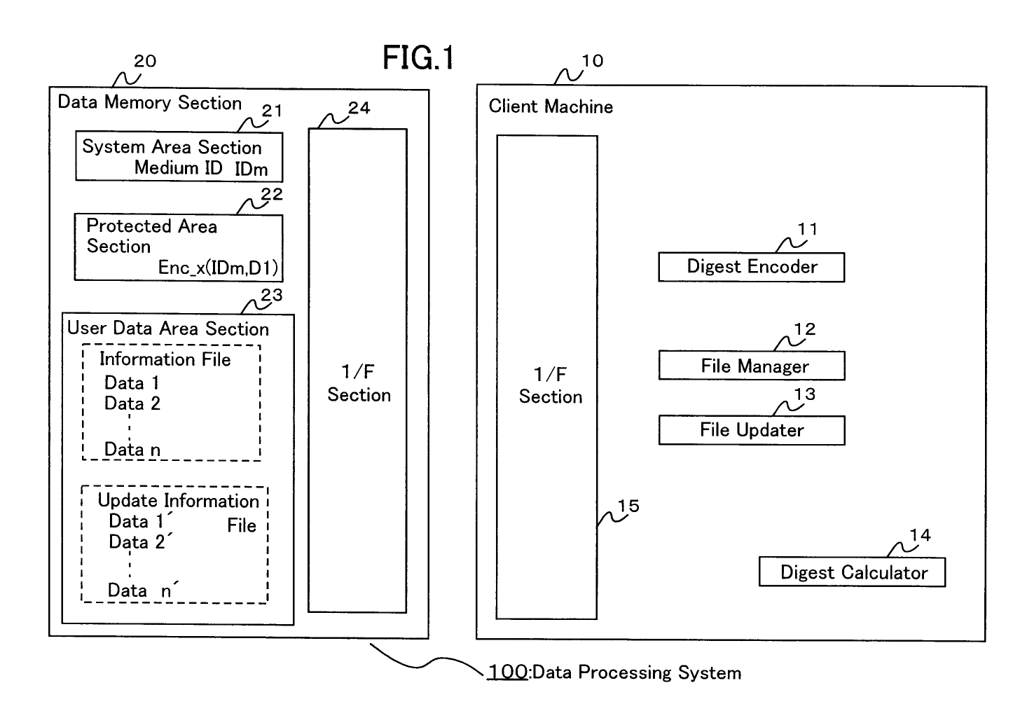

Preferred embodiments of a processing apparatus, a data processing method and a data processing computer program product, that is, a data processing system according to the present invention will now be described in detail with reference to the appending drawings. FIG. 1 is a block diagram that illustrates a constructive example of a part according to a data updating process in a data processing system 100. As shown in FIG. 1, the data processing system 100 is constructed from an information processing apparatus such as a personal computer. The data processing system 100 includes a client machine 10 and a data memory section 20.

The client machine 10 includes a digest encoder 11, a file manager 12, a file updater 13, a digest calculator 14, and an interface section (I/F section) 15. The interface section 15 is used to access the data memory section 20. The data memory section 20 includes a system area section 21, a protected area section 22, a user data area section 23, and an interface section (I/F section) 24. A medium ID that is a medium identifier of a data storage section 20 is stored in the system area section 21. An encoded digest value that is encoded by the digest encoder 11 in the client machine 10 is stored in the protected area section 22. An information file and/or an update information file in which the information file is updated are stored in the user data area section 23. The interface section 24 is used to access the client machine 10.

The protected area section 22 is an area that is hardly accessed in which tamper resistance is heightened. Access to the protected area section 22 is limited by executing a certification process between the data memory section 20 and the client machine 10 or the like in advance. The user data area section 23 is not provided with such access limitation, in particular. However, in the protected area section 22, the tamper resistance may not be an essential condition for the protected area.

In this regard, in the present embodiment, the term “Data n” means n^{th} information. Further, the term “Dn” (here, “n”=1, 2 . . . ) means a digest value created from an information file by means of the digest calculator 14. Moreover, the term “IDm” means a medium identifier (medium ID) of the “m” data storage section 20. Furthermore, the term “Enc_x (A, B)” means encoded data in which information “B” is encoded using key information “A” in an encryption method “x”.

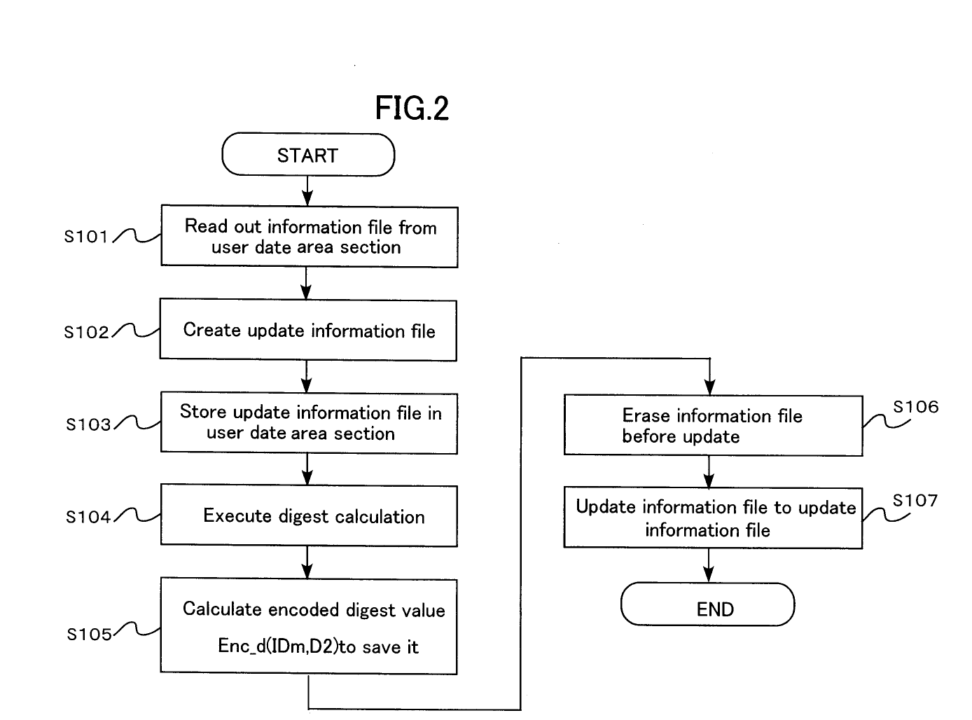

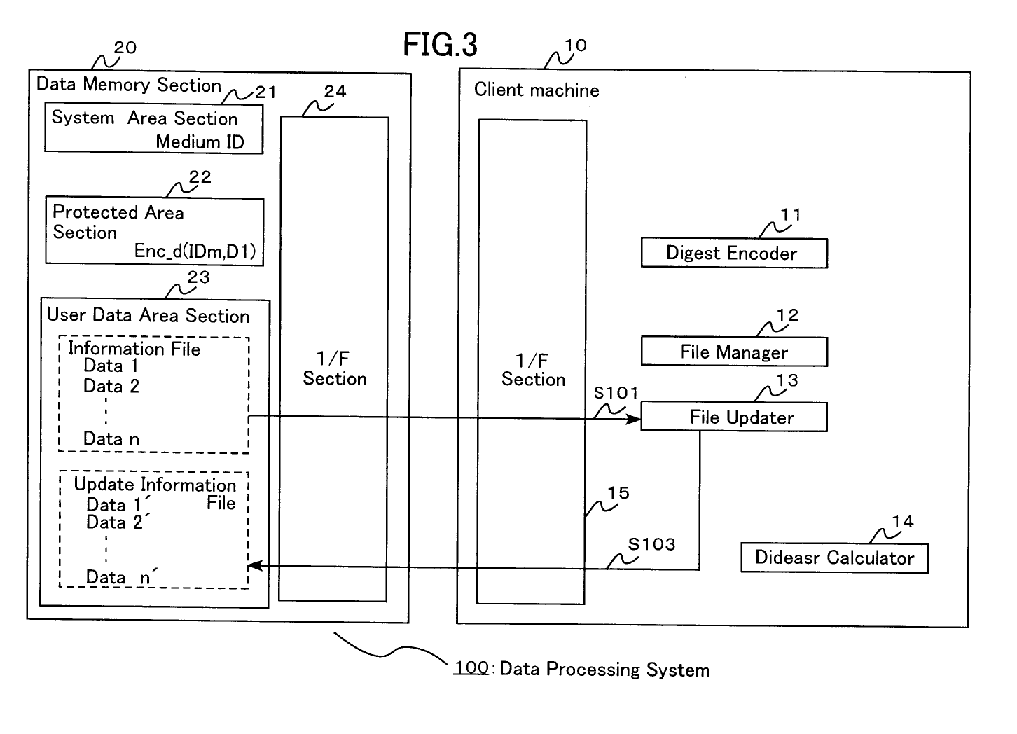

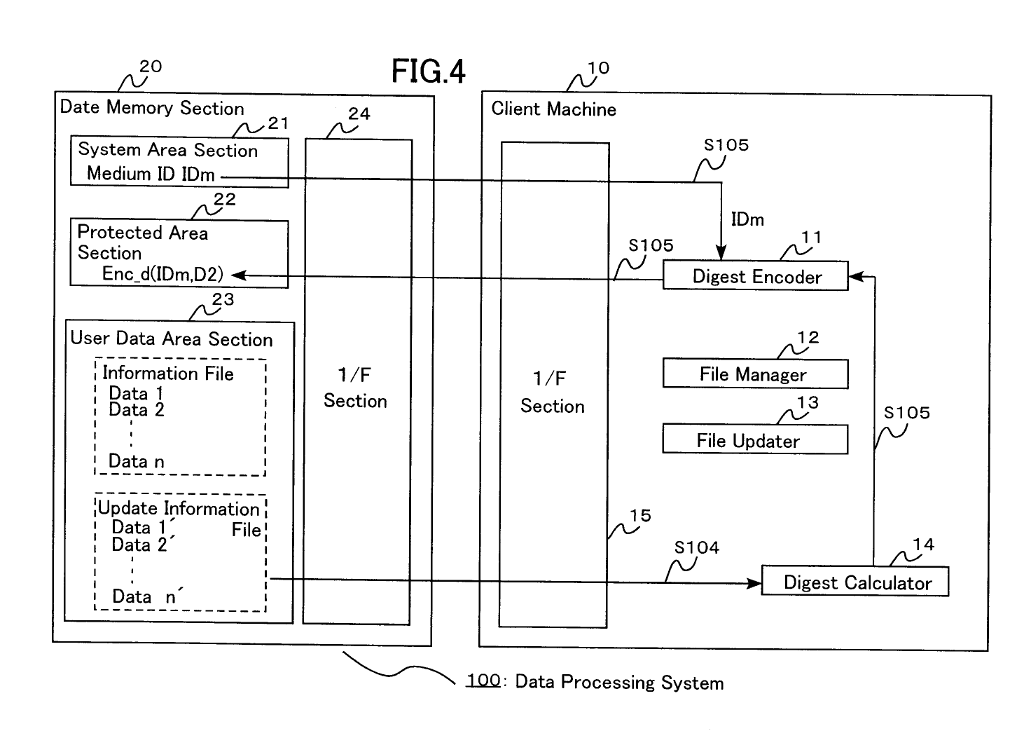

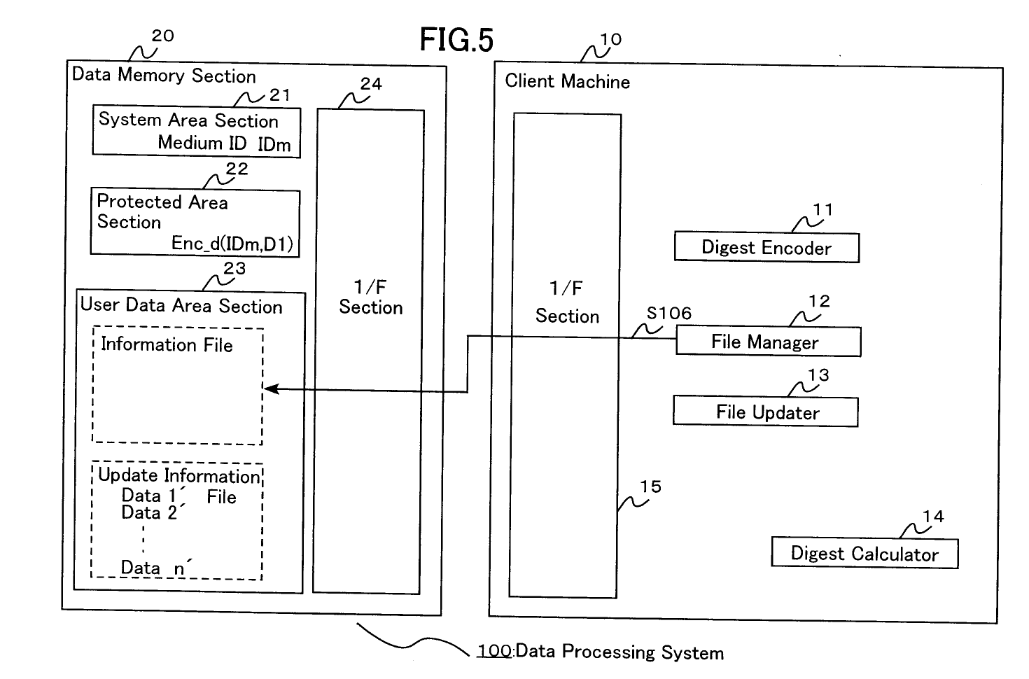

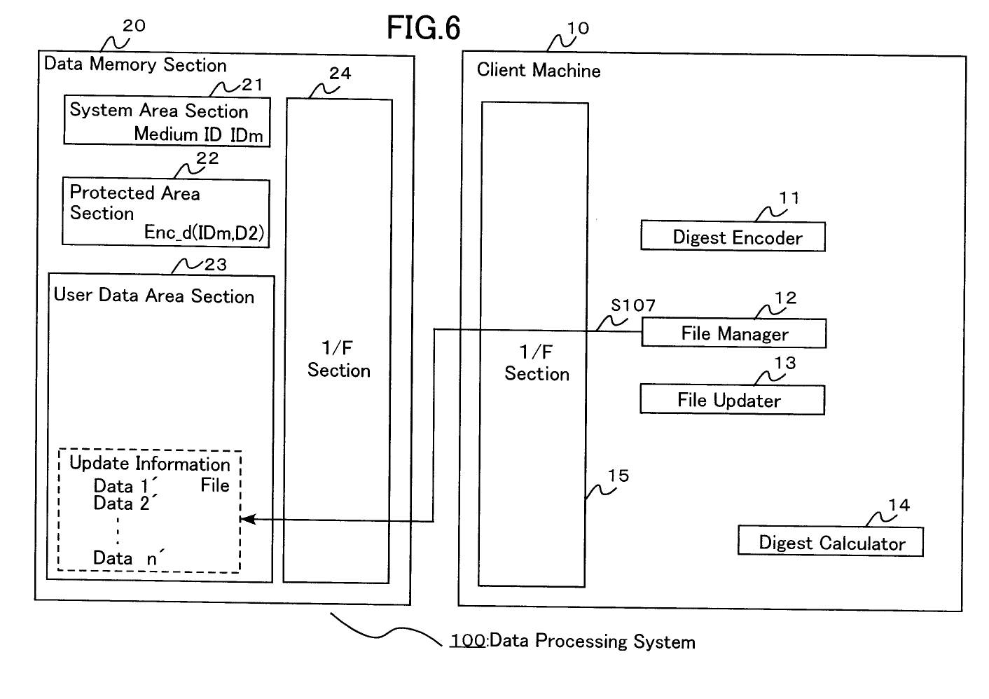

Next, a data update process that the data processing system 100 according to the present embodiment may execute will now be described with reference to FIGS. 2 to 6. FIG. 2 is a flowchart that illustrates an example of the data updating process that the data processing system 100 executes. FIG. 3 is an explanatory drawing that shows an outline of the data updating process that corresponds to Steps S101 to S103 of the flowchart in FIG. 2. FIG. 4 is an explanatory drawing that shows an outline of the data updating process that corresponds to Steps S104 to S105 of the flowchart in FIG. 2. FIG. 5 is an explanatory drawing that shows an outline of the data updating process that corresponds to Step S106 of the flowchart in FIG. 2. FIG. 6 is an explanatory drawing that shows an outline of the data updating process that corresponds to Step S107 of the flowchart in FIG. 2.

In the data update process, the file updater 13 first reads out an information file stored in the user data area section 23 (Step S101). When an update information file is created by updating the contents of the information file by a user who operating the client machine 10 (Step S102), the file updater 13 stores the update information file in the user data area section 23 (Step S103). In this regard, the term “update information file” means an information file after being subjected to an update process.

Subsequently, the digest calculator 14 reads out the update information file stored in the user data area section 23, and executes a calculation for a digest value D2 with respect to the update information file (Step S104). The digest encoder 11 reads out a medium ID (IDm) from the system area section 21 of the data memory section 20 via the interface section 24. The digest encoder 11 also receives a digest value D2 from the digest calculator 14 to calculate an encoded digest value Enc_d (IDm, D2). The digest encoder 11 then overwrites the calculated encoded digest value Enc_d (IDm, D2) as described above onto an encoded digest value Enc_d (IDm, D1) stored in the protected area section 22 (Step S105). In this regard, the term “Enc_d (A, B)” means encoded data in which information “B” is encoded using a function “d” as key information “A”.

Subsequently, the file manager 12 erases the information file before the update process (Step S106). The file manager 12 then updates the update information file as an information file after update (Step S107). When the update information file is updated to the information file, the data update process (that is, file update) is completed.

As described above, the data processing system 100 is constructed so that: an update information file is created on the basis of an information file including multiple pieces of data “1” to data “n”, which are stored in the user data area section 23, to be stored in the user data area section 23; a digest value D2 is calculated from the created update information file; a digest value D1 stored in the protected area section 22 is updated to the calculated digest value D2; the information file used to create the update information file is erased; and the update information file is set as an information file. Thus, it is possible to execute an update process for a protected information file so as to be recoverable even in the case where the update process is interrupted without completing the update process.

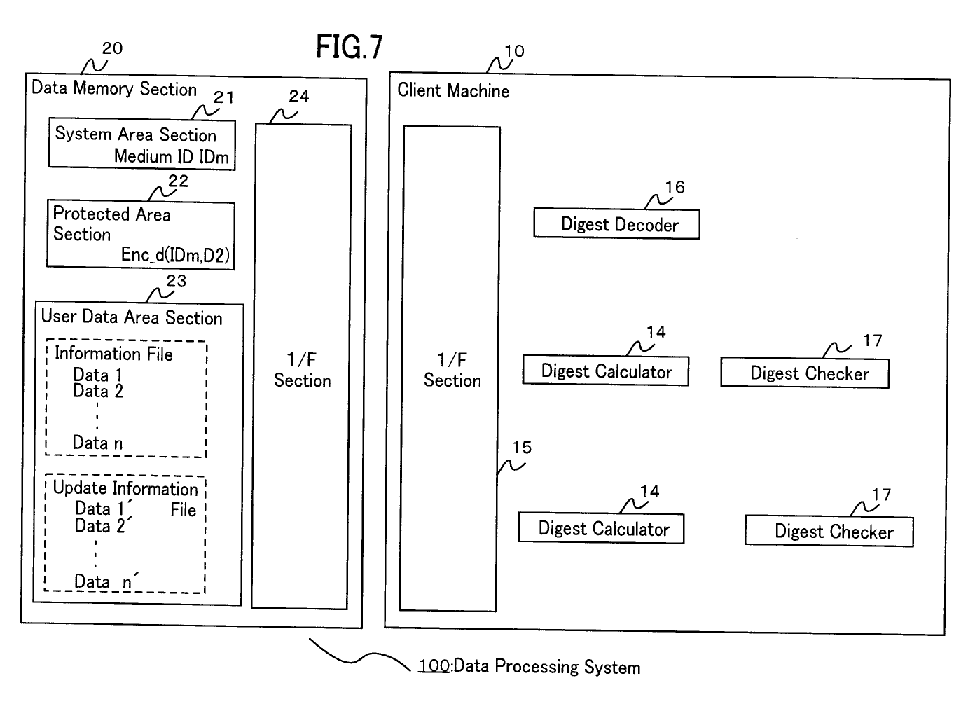

FIG. 7 is a block diagram that illustrates a constructive example of a part according to a data restoring process in a data processing system 100. A client machine 10 includes, as a part for the data restoring process, a digest decoder 16, a digest calculator 14, a digest checker 17, and an interface section (I/F section) 15. The interface section 15 is used to access a data memory section 20.

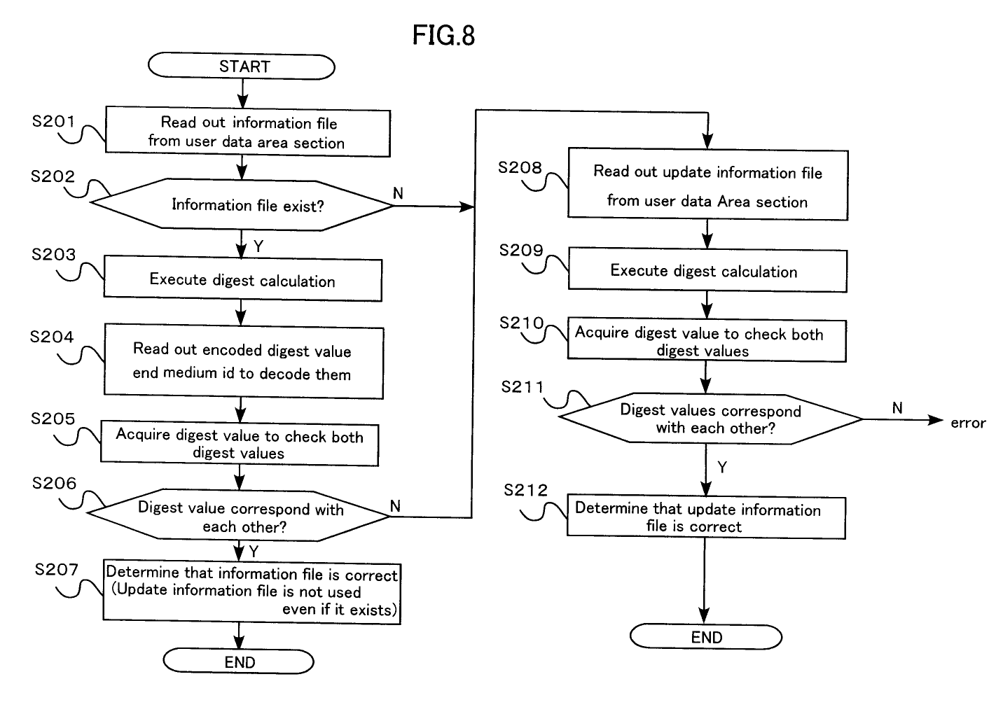

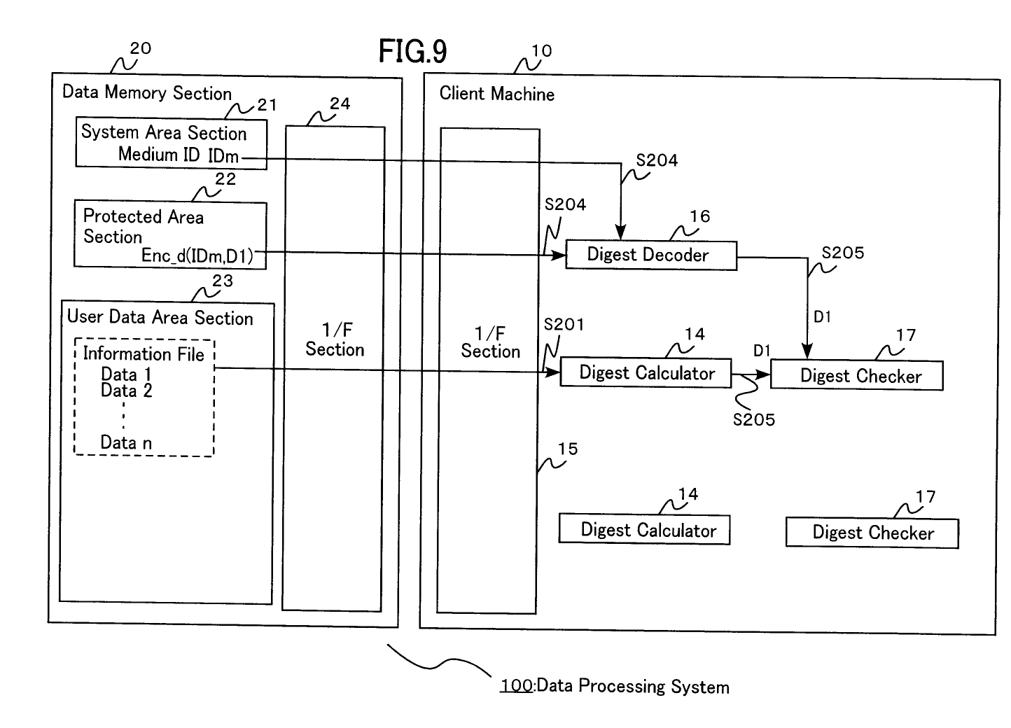

Next, a data restoring process that the data processing system 100 according to the present embodiment may execute will now be described with reference to FIGS. 8 to 12. FIG. 8 is a flowchart that illustrates an example of the data restoring process that the data processing system 100 executes. FIGS. 9 to 12 are explanatory drawings that show an outline of the data restoring process in accordance with a memory state of the data memory section 20. The data restoring process is executed when a data update process is interrupted, when there is an instruction from an operator, and the like, for example.

FIG. 9 shows a process of the data processing system 100 when the data memory section 20 is in a normal state (that is, in the case where the process when updating a digest value of an information file is normally completed without interruption). In the data restoring process, the digest calculator 14 first reads out an information file stored in the user data area section 23 (Step S201). In the case where it is determined that there is an information file (“Yes” at Step S202), the digest calculator 14 calculates a digest value D1 for the read out information file (Step S203). On the other hand, the digest decoder 16 reads out an encoded digest value Enc_d (IDm, D1) that is stored in the protected area section 22 in advance and a medium ID (IDm) stored in the system area section 21. The digest decoder 16 then obtains a digest value D1 by decoding the read out encoded digest value uding the medium ID (IDm) (Step S204). In this regard, the term “Enc_d (A, B)” means encoded data in which information “B” is encoded using a function “d” as key information “A”.

The digest checker 17 respectively obtains the digest values from the digest calculator 14 and the digest decoder 16 to check the digest values (Step S205). In the case where the digest values that are comparison subjects are concordance to each other (“Yes” at Step S206), the digest checker 17 determines that the information file stored in the data memory section 20 is correct (Step S207). The data restoring process is terminated without executing a restoring process.

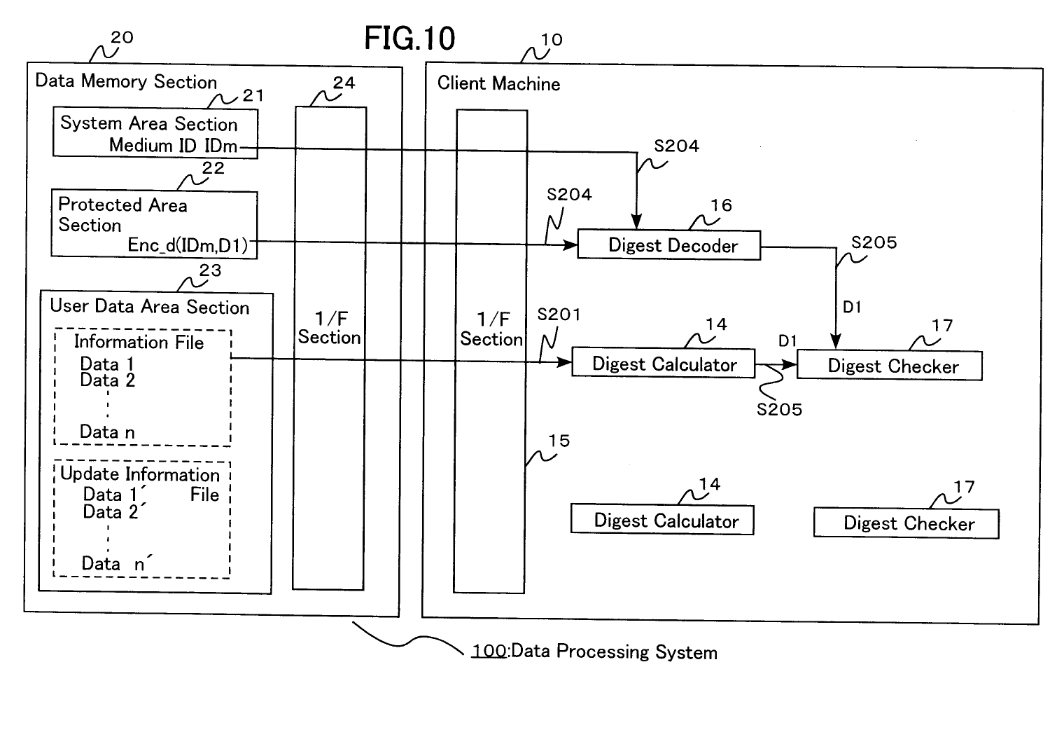

FIG. 10 is an explanatory drawing that shows an outline of a process of the data processing system 100 in the case where the data restoring process is executed from the state that the data update process for the information file is interrupted at a situation as shown in FIG. 3 (Steps S101 to S103). In this case, the processes similar to those described above as shown in FIG. 9 (that is, Steps S201 to S207) are executed. In this example, the digest checker 17 also determines that the digest value D1 obtained by decoding the encoded digest value stored in the protected area section 22 is concordance to (or corresponds with) the digest value obtained from the information file (“Yes” at Step S206). The digest checker 17 thereby determines that the information file stored in the user data area section 23 of the data memory section 20 is correct (Step S207). Further, in this example, although the update information file exists in the user data area section 23, the digest checker 17 determines that the update information file is not utilized for the data restoring process.

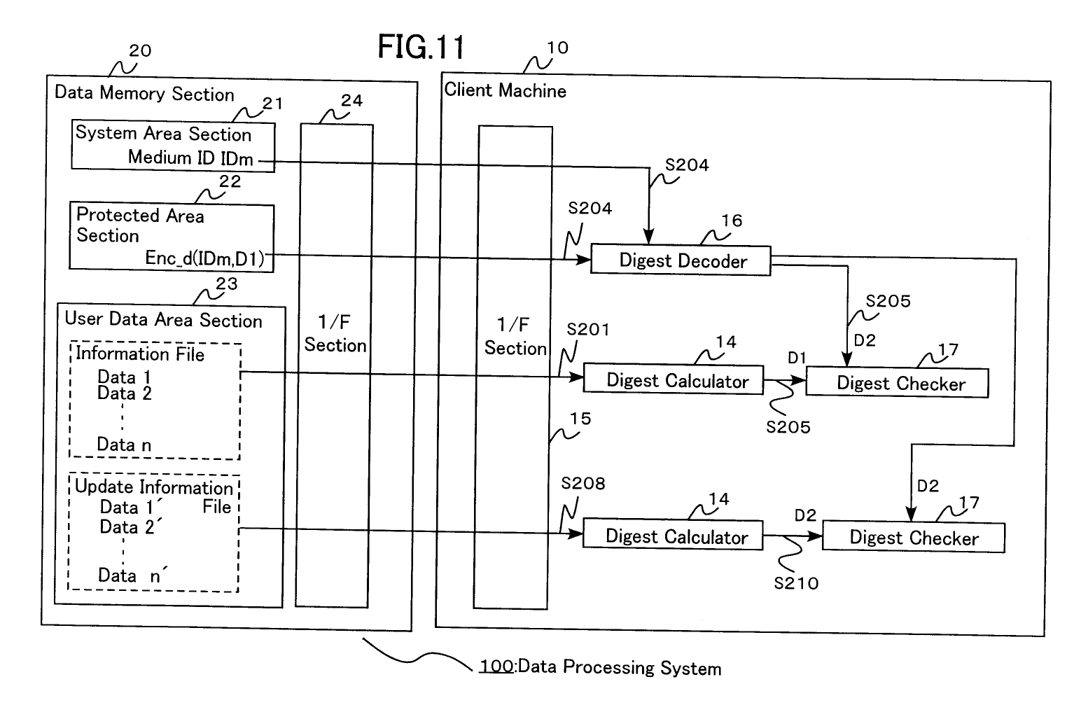

FIG. 11 is an explanatory drawing that shows an outline of a process of the data processing system 100 in the case where the data restoring process is executed from the state that the data update process for the information file is interrupted at a situation as shown in FIG. 4 (Steps S104 and S105). In this case, after executing the processes of Steps S201 to S205 as described above, the digest checker 17 determines that the digest value obtained by decoding the encoded digest value stored in the protected area section 22 of the data storage section 20 using the medium ID (IDm) is not concordance to (or does not correspond with) the digest value calculated for the information file (“No” at Step S206). The digest checker 17 thereby determines that the information file stored in the data memory section 20 is incorrect. The digest calculator 14 then reads out the update information file stored in the user data area section 23 (Step S208) to calculate a digest value D2 (Step S209). Next, the digest checker 17 checks the digest value decoded at Step S204 against the digest value included in the update information file (Step S210). In this example, at Step S204, it is executed the processes in which the digest encoder 16 reads out an encoded digest value Enc_d (IDm, D2) and a medium ID (IDm), and decodes the encoded digest value to obtain a digest value D2.

Then, when the digest checker 17 confirms that the digest values that are comparison subjects are concordance to each other (“Yes” at Step S211), the digest checker 17 determines that the update information file stored in the user data area section 23 is a correct value (Step S212). The processing flow then proceeds from Step S104 (see FIG. 2) that corresponds to a process after the data update process for the information file described above.

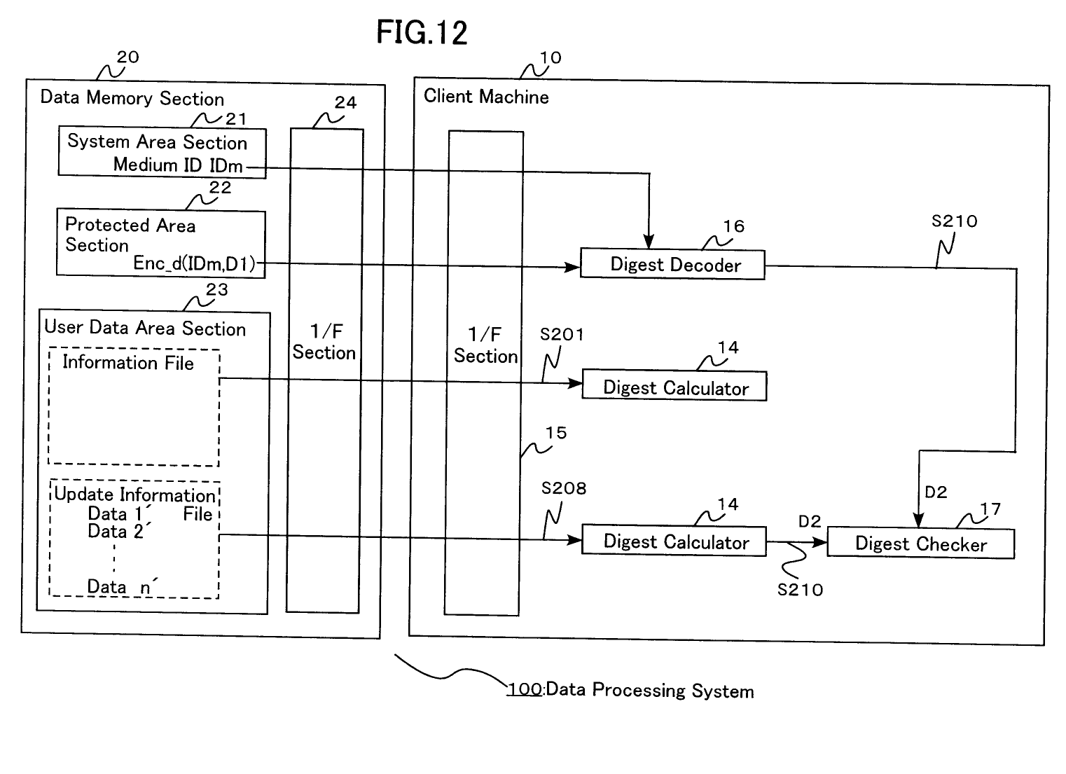

FIG. 12 is an explanatory drawing that shows an outline of a process of the data processing system 100 in the case where the data restoring process is executed from the state that the data update process for the information file is interrupted at a situation as shown in FIG. 5. In this case, since there is no information file, the digest decoder 16 determines “No” at Step S202 described above. Thus, the processing flow proceeds to Step S208. The digest calculator 14 then reads out the update information file stored in the user data area section 23 (Step S208) to calculate a digest value D2 (Step S209). In this case, the digest decoder 16 reads out an encoded digest value Enc_d (IDm, D2) and a medium ID (IDm), and it is executed the process in which the digest decoder 16 decodes the encoded digest value to obtain a digest value D2. Next, the digest checker 17 checks the digest value thus decoded against the digest value included in the update information file (Step S210).

Then, when the digest checker 17 confirms that the digest values of comparison subjects are concordance to each other (“Yes” at Step S211), the digest checker 17 determines that the update information file stored in the user data area section 23 is a correct value (Step S212). The processing flow then proceeds from Step S104 (see FIG. 2) that corresponds to a process after the data update process for the information file described above.

In the present embodiment, in the case where it is confirmed that the digest values of the information files are not concordance to each other (“No” at Step S211), each of the information file and the update information file is treated as a file that may have suffered falsification.

The execution of the processes as described above allows an information file to be restored to either the information file before or after the data update process even in the case where the data update process is interrupted at any point of time in the data update process. Namely, for example, the data processing system 100 is constructed so that: the digest updater 13 reads out the information file stored in the user data area section 23; the digest calculator 14 calculates a digest value from the read out information file; the digest checker 17 checks the calculated digest value against the digest value stored in the protected area section 22; the digest calculator 14 calculates a digest value from the update information file remaining in the user data area section 23 in the case where the check result is not concordance (that is, the digest values are not concordance to each other); the digest checker 17 checks the calculated digest value against the digest value stored in the protected area section 22; and the file manager 12 sets the update information file as an information file in the case where the check result is concordance (that is, the digest values are concordance to each other). Thus, it is possible to recover a protected information file in the case where a data update process for the protected information file is interrupted without completing the data update process.

In this regard, although it has not referred to in the embodiment described above, each section constituting the data processing system 100 executes the respective processes described above in accordance with a data processing program installed in the inside of the data processing system 100. In addition, although an assembly of the client machine 10 and the data memory section 20 is expressed as the data processing system 100 in the embodiment described above, the present invention is not limited to such a system. For example, the assembly of the client machine 10 and the data memory section 20 may be expressed as an apparatus.

Further, in the embodiment described above, the data processing system 100 is constructed so that the digest value is encoded and then stored in the protected area section 22. However, the digest value may be stored in the protected area section 22 as it is without being encoded.

Moreover, the calculation method for the digest value at Step S211 may include a method of indirectly obtaining an effect to prevent falsification by calculating a digest value on the basis of check data information, such as a key to encode information for which a user hopes to prevent falsification and a check sum of information for which a user hopes to prevent falsification.

What is claimed is:

1. A data processing apparatus for managing an information file to be utilized when contents are used, the data processing apparatus comprising:
a first update information file creator for creating an update information file on the basis of an information file stored in a predetermined file storage area, and for storing the created update information file in the predetermined file storage area;
a first digest calculator for calculating a digest value from the update information file created by the first update information file creator;
a digest updater for updating a digest value stored in a predetermined digest value storage area to the digest value calculated by the first digest calculator;
a file eraser for erasing the information file used to create the update information file; and
a first file setter for setting the update information file as an information file.

2. The data processing apparatus according to claim 1, wherein an encoded digest value obtained by encoding the digest value calculated from the information file in advance using a medium identifier is stored in the predetermined digest value storage area, and
wherein the digest updater updates the encoded digest value stored in the predetermined digest value storage area to the encoded digest value obtained by encoding the digest value from the update information file calculated by the first digest calculator using the medium identifier.

3. The data processing apparatus according to claim 1, further comprising:
a second digest calculator for reading out the information file stored in the predetermined file storage area, the second digest calculator calculating a digest value from the read out information file;
a first digest checker for checking the digest value calculated by the second digest calculator against the digest value stored in the predetermined digest value storage area;
a second update information file creator for creating an update information file on the basis of the information file stored in the predetermined file storage area in the case where a check result of the first digest checker is not concordance;
a third digest calculator for calculating a digest value from the update information file created by the second update information file creator;
a second digest checker for checking the digest value calculated by the third digest calculator against the digest value stored in the predetermined digest value storage area; and
a second file setter for setting the update information file as an information file in the case where a check result of the second digest checker is concordance.

4. The data processing apparatus according to claim 3, wherein an encoded digest value obtained by encoding the digest value calculated from the information file in advance using a medium identifier is stored in the predetermined digest value storage area,
wherein the digest updater updates the encoded digest value stored in the predetermined digest value storage area to the encoded digest value obtained by encoding the digest value from the update information file calculated by the first digest calculator using the medium identifier, and
wherein the first digest checker checks the digest value calculated by the second digest calculator against the digest value obtained by decoding the encoded digest value stored in the predetermined digest value storage area using the medium identifier.

5. The data processing apparatus according to claim 3, wherein an encoded digest value obtained by encoding the digest value calculated from the information file in advance using a medium identifier is stored in the predetermined digest value storage area,
wherein the digest updater updates the encoded digest value stored in the predetermined digest value storage area to the encoded digest value obtained by encoding the digest value from the update information file calculated by the first digest calculator using the medium identifier,
wherein the first digest checker checks the digest value calculated by the second digest calculator against the digest value obtained by decoding the encoded digest value stored in the predetermined digest value storage area using the medium identifier, and
wherein the second digest checker checks the digest value calculated by the third digest calculator against the digest value obtained by decoding the encoded digest value stored in the predetermined digest value storage area using the medium identifier.

6. A method of processing data by managing an information file to be utilized when contents are used, the method comprising:
creating an update information file on the basis of an information file stored in a predetermined file storage area, and storing the created update information file in the predetermined file storage area;
calculating a digest value from the update information file created in the creating an update information file step;
updating a digest value stored in a predetermined digest value storage area to the digest value calculated in the calculating a digest value step;
erasing the information file used to create the update information file; and
setting the update information file as an information file.

7. The method according to claim 6, wherein an encoded digest value obtained by encoding the digest value calculated from the information file in advance using a medium identifier is stored in the predetermined digest value storage area, and
wherein the encoded digest value stored in the predetermined digest value storage area is updated to the encoded digest value obtained by encoding the digest value from the calculated update information file using the medium identifier.

8. The method according to claim 6, further comprising:
reading out an information file stored in the predetermined file storage area, and calculating a digest value from the read out information file;
checking the digest value calculated from the read out information file against the digest value stored in the predetermined digest value storage area;
creating an update information file on the basis of the information file stored in the predetermined file storage area in the case where a check result in the checking the digest value calculated from the read out information file step is not concordance;
calculating a digest value from the created update information file;
checking the digest value calculated from the update information file against the digest value stored in the predetermined digest value storage area; and
setting the update information file as an information file in the case where a check result in the checking the digest value calculated from the update information file step is concordance.

9. The method according to claim 8, wherein an encoded digest value obtained by encoding the digest value calculated from the information file in advance using a medium identifier is stored in the predetermined digest value storage area,
wherein in the updating a digest value stored in a predetermined digest value storage area step, the encoded digest value stored in the predetermined digest value storage area is updated to the encoded digest value obtained by encoding the digest value from the update information file calculated in the calculating a digest value from the update information file step using the medium identifier, and
wherein in the checking the digest value calculated from the read out information file step, the digest value calculated in the checking the digest value calculated from the update information file step is checked against the digest value obtained by decoding the encoded digest value stored in the predetermined digest value storage area using the medium identifier.

10. The method according to claim 8, wherein an encoded digest value obtained by encoding the digest value calculated from the information file in advance using a medium identifier is stored in the predetermined digest value storage area,
wherein in the updating a digest value stored in a predetermined digest value storage area step, the encoded digest value stored in the predetermined digest value storage area is updated to the encoded digest value obtained by encoding the digest value from the update information file calculated in the calculating a digest value from the update information file step using the medium identifier,
wherein in the checking the digest value calculated from the read out information file step, the digest value calculated in the calculating a digest value from the read out information file step is checked against the digest value obtained by decoding the encoded digest value stored in the predetermined digest value storage area using the medium identifier, and
wherein in the checking the digest value calculated from the update information file step, the digest value calculated in the calculating a digest value from the created update information file step is checked against the digest value obtained by decoding the encoded digest value stored in the predetermined digest value storage area using the medium identifier.
